(19) United States
(12) Patent Application Publication
(10) Pub. No.: US 2007/0166505 A1
(43) Pub. Date: Jul. 19, 2007

(54) Optical storage medium, manufacturing method of recording layer thereof, and recording method thereof

(76) Inventor: Fung-Hsu Wu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/457,146

(22) Filed: Jul. 12, 2006

(30) Foreign Application Priority Data
Jan. 13, 2006 (TW) 095101494

(51) Int. Cl. B32B 3/02

(52) U.S. Cl. 428/64.4

(57) ABSTRACT

An optical storage medium, a manufacturing method of a recording layer thereof, and a recording method thereof are disclosed, wherein a stack of multiple metal layers is used as a recording layer. A recorded mark having a reflectivity different from those of two adjacent metal layers will be produced at an interface between the two adjacent metal layers by irradiation of a laser beam on the interface.

### BACKGROUND OF THE INVENTION

1. Field of the Invention

The present invention relates to a storage medium, and more particularly to an optical storage medium, a manufacturing method of a recording layer thereof, and a recording method thereof.

2. Description of the Prior Art

Optical discs have become a popular storage media due in part to their ease of use, low cost, portability, and high capacity. For example, a conventional CD disc has a data capacity of about 650 MB to 800 MB; a DVD-5 disc has a data capacity of 4.7GB; a DVD-9 disc has a data capacity of 8.5 GB; and the newly introduced blu-ray disk (BD) has an even greater data capacity of over 20 GB.

Recording layer materials used in the optical storage medium are developed constantly to follow up the requirement of increasing data capacity of optical discs. Please refer to FIG. 1. Schematic diagram of cross-sectional view of a conventional write-once storage medium 10 using an organic dye layer as a recording layer is shown in FIG. 1. The write-once storage medium 10 comprises a substrate 12, an organic dye layer as a recording layer 14 positioned on the substrate 12, a reflective layer 16 positioned on the recording layer 14, a protective layer 18 positioned on the reflective layer 16. The write-once storage medium 10 utilizes a laser beam 11 emitting from an optical pick-up head through the substrate 12, and irradiating on the recording layer 14 to record data in the recording layer 14, or read data stored in the recording layer 14.

Traditionally, an organic dye is used as a material of the recording layer, and the material has a different structure varied by heating when irradiated by the laser beam. For example, a decomposition reaction occurs and bubbles are produced to provide differentiation between recorded area and unrecorded area. However, the data capacity of optical discs becomes larger, i.e. the track pitch of optical discs becomes smaller correspondingly. For example, the track pitch of blu-ray optical disc is about 0.3 to 0.4 micrometers (um). Therefore, using conventional organic dye layer as the recording layer has disadvantages and problems of high cost in manufacturing, difficult formulation, complicated solvent system, sensitivity to laser beam wavelength, poor endurance, short lifetime, environment pollution, and non-uniform coating. Therefore, an inorganic material layer is developed to replace the organic dye layer as the recording layer of write-once storage medium.

Please refer to FIG. 2. Schematic cross-sectional diagram of another conventional write-once storage medium 20 is shown in FIG. 2. The write-once storage medium 20 comprises a substrate 22, a lower dielectric layer 24 positioned on the substrate 22, a recording layer 26 positioned on the lower dielectric layer 24, an upper dielectric layer 28 positioned on the recording layer 26, and a reflective layer 30 positioned on the upper dielectric layer 28. The write-once storage medium 20 utilizes a laser beam 21 emitting from an optical pick-up head through the lower dielectric layer 24, and irradiating on the recording layer 26 to record data in the recording layer 26, or read data stored in the recording layer 26.

For example, conventional materials of the recording layer 26 include materials disclosed as follows. U.S. Patent Application Publication No. 2004/0166440A1 discloses a composition (SbₓTe₁₋ₓ)ₐGe_{b}In_{c}, wherein 0.77≦x≦0.84, 0.85≦a≦0.95, 0.01≦b≦0.10, 0.01≦c≦0.10, and a+b+c=1, as the material of the recording layer. The Japan Patent Laid-Open Publication No. 5(1993)-16528 and 5(1993)-4453 disclose a Ge—Sb—Te alloy, or Ge—Sb—Te—In alloy as the material of the recording layer. The Japan Patent No. 3150267 discloses a Ge (or Si)—Ag—ln—Sb—Te alloy, i.e. Ge or Si is added in Ag—In—Sb—Te alloy, as the material of the recording layer. The Japan Patent Laid-Open Publication No. 2002-264515 discloses a mixture of Ge, In, Sb, and Te as the material of the recording layer. The Japan Patent Laid-Open Publication No. 2000-313170 discloses a compound [(SbₓTe₁₋ₓ)_{y}Ge_{1-y}], _{z}M_{1-z}, wherein 0.7≦x≦0.9, 0.8≦y<1, 0.88≦z<1, and M is In and/or Ga as the material of the recording layer. The U.S. Patent Application Publication No. 2004/241376 discloses a alloy or a compound of silicon (Si) or tin (Sn) with aluminum (Al), silver (Ag), gold (Au), zinc (Zn), titanium (Ti), nickel (Ni), copper (Cu), cobalt (Co), tantalum (Ta), iron (Fe), tungsten (W), chromium (Cr), vanadium (V), gallium (Ga), lead (Pb), molybdenum (Mo), indium (In), or antimony (Sb) as the material of the recording layer. All of the materials are mixed metal elements, alloys, or compounds, and formed as a single recording layer in the optical storage medium for data recording.

There is still a need to research and develop for an applicable storage medium.

### SUMMARY OF THE INVENTION

The present invention provides an optical storage medium, a manufacturing method of recording layers thereof, and a recording method thereof, wherein a stack of multiple metal layers is used as a recording layer in the optical storage medium, and it is easy to manufacture, and the problem of non-uniform coating does not exist.

The optical storage medium according to the present invention comprises a substrate, a first protective layer positioned on the substrate, a first multiple metal recording layer positioned on the first protective layer, a second protective layer positioned on the first multiple metal recording layer, and a covering layer positioned on the second protective layer, wherein a recorded mark is produced at an interface between two adjacent metal layers of the first multiple metal recording layer by irradiation of a laser beam on the interface and has a different reflectivity from those of the two adjacent metal layers.

The method of manufacturing a recording layer of an optical storage medium according to the present invention comprises providing a substrate with a protective layer positioned on a surface thereof, and forming a multiple metal layer on the protective layer in sequence to form a recording layer of an optical storage medium.

The recording method for an optical storage medium comprising a multiple metal layer as a recording layer according to the present invention comprises irradiating a laser beam on an interface between two adjacent metal layers of a multiple metal layer to change an irradiated part of the interface to have a reflectivity different from those of the two adjacent metal layers to form a recorded mark.

In the optical storage medium according to the present invention, the recording layer comprises a stack of multiple metal layers easily manufactured using, for example, a physical vapor deposition process, and the stack of multiple metal layers are uniform coated. The present invention is applicable for CD, DVD-5, DVD-9, blu-ray disc and the like, and the present invention is also applicable for the track pitch small down to 0.3 to 0.4 micrometers or less.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional diagram of a conventional write-once storage medium using an organic dye layer as a recording layer.

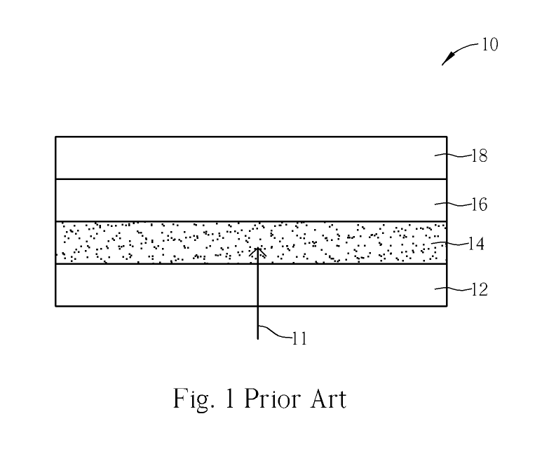

FIG. 2 is a schematic cross-sectional diagram of another conventional write-once storage medium.

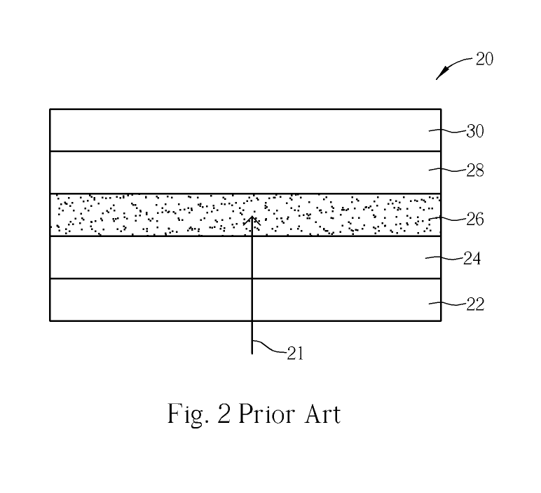

FIG. 3 shows a schematic cross-sectional diagram of an embodiment of the optical storage medium according to the present invention.

FIG. 4 shows a schematic cross-sectional diagram of another embodiment of the optical storage medium according to the present invention.

FIG. 5 shows a schematic cross-sectional diagram of further another embodiment of the optical storage medium according to the present invention.

### DETAILED DESCRIPTION

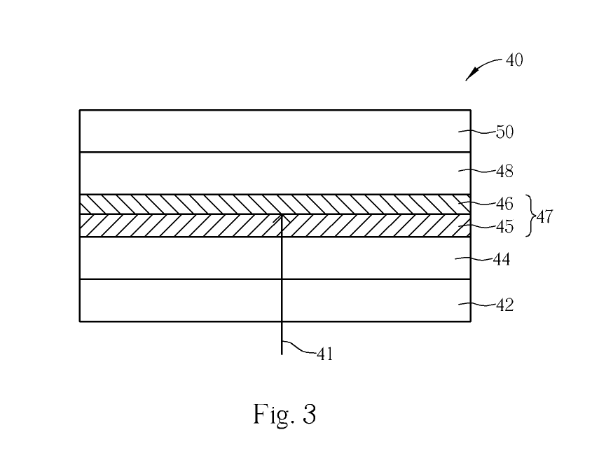

Please refer to FIG. 3. FIG. 3 shows an embodiment of the optical storage medium 40 according to the present invention. The optical storage medium 40 comprises a substrate 42, a first protective layer 44, a recording layer 47 comprising a metal layer 45 and a metal layer 46, a second protective layer 48, and a covering layer 50.

The materials that can be used for the substrate 42 are, for example, glass, polycarbonate (PC), polymethylmethacrylate (PMMA), polyolefin, epoxy, polyimide and the like. In general, the thickness of the substrate 42 is about 0.01 mm to 5 mm as desired, and it is not limited.

The materials that can be used for the protective layer 44 or 48 are transparent to the laser beam for writing and reading data, for example, the materials with refractive index of 1.5 to 2.3. In general, the first protective layer 44 and the second protective layer 48 are dielectric layers or composite dielectric layers, and may comprise different materials, for example, silicon nitrides (SiNₓ), zinc sulfide-silicon oxides (ZnS-SiO₂), aluminum nitrides (AlNₓ), silicon carbide (SiC), germanium nitrides (GeNₓ), titanium nitrides (TiNₓ), tantalum oxides (TaOₓ), yttrium nitrides (YOₓ), or a combination thereof. The thickness of the first protective layer 44 is in the range of from about 5 nm to 500 nm in general, and preferred from 40 to 300 nm. The thickness of the second protective layer 48 is in the range of from about 0.5 nm to 50 nm in general.

In the optical storage medium according to the present invention, the recording layer is a multiple metal layer, different from the single material recording layer in the prior art. In the embodiment of the optical storage medium 40, the recording layer 47 comprises two metal layers, i.e. the metal layer 45 and the metal layer 46, between the first protective layer 44 and the second protective layer 48. The materials that can be used for the metal layers are, for example, indium and tin. For example, the metal layer 45 can be an indium layer, and the metal layer 46 can be a tin layer, or the metal layer 45 can be a tin layer, and the metal layer 46 can be an indium layer. The thickness of the metal layer 45 is in the range of from about 3 nm to 30 nm, and the thickness of the metal layer 46 is in the range of from about 3 nm to 50 nm. Since the optical storage medium 40 does not comprise any reflective layer in this embodiment, the thickness of the metal layer 46 can be a little thicker to attain a reflectivity over about 10 percent, and the metal layer 46 can possess the function as a reflective layer.

The second protective layer 48 is covered with the covering layer 50, and the material used for the covering layer 50 may comprise plastic, such as photo-curing resins.

An indium layer and a tin layer are used in the optical storage medium 40 as the recording layer, and the recording method is to utilize a laser beam 41 to irradiate an interface between the indium layer and the tin layer, and thereby an irradiated part of the interface is changed or transformed, presumed to form an alloy of In—Sn, to have a decreased reflectivity different from those of the two adjacent metal layers to form a recorded mark, i.e. writing of a recording signal. In this way, the recorded area and the unrecorded area with different brightness are formed on an optical disc and have different reflectivity read by the laser beam, and thus, perform as data “0” and “1”, i.e. reading of a recording signal. Please note that the indium layer can be formed on the first protective layer 44 first, and then the tin layer is formed on the indium layer, or the tin layer can be formed on the first protective layer 44 first, and then the indium layer is formed on the tin layer. Since the change or transformation is irreversible, the optical storage medium 40 is a write-once storage medium in this embodiment.

A multiple metal layer is used as a recording layer in the optical storage medium 40 according to the present invention. The metal layers may be formed by a physical vapor deposition (PVD) process, for example, a sputtering or evaporation process. For example, an indium layer is first formed using sputtering, and then a tin layer is formed using sputtering, or in the reverse orders. In such way, it is also applicable for manufacturing a recording layer with a track pitch narrowing down to 0.3 to 0.4 micrometers, and the recording layer is uniformly coated.

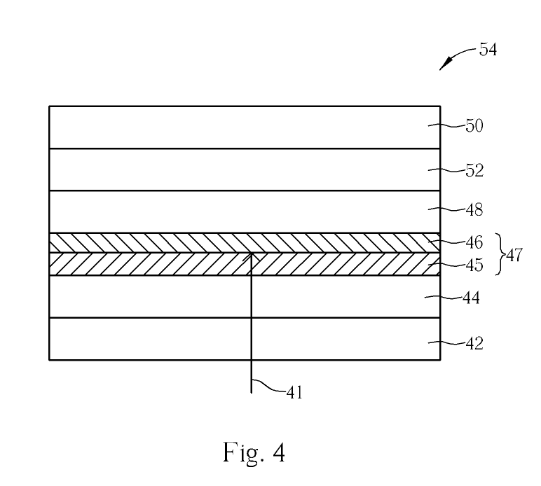

Please refer to FIG. 4. FIG. 4 shows another embodiment of the optical storage medium 54 according to the present invention. The optical storage medium 54 comprises a substrate 42, a first protective layer 44, a recording layer 47 comprising a metal layer 45 and a metal layer 46, a second protective layer 48, a reflective layer 52, and a covering layer 50, i.e. there is one more reflective layer 52 positioned between the second protective layer 48 and the covering layer 50 in the comparison with the optical storage medium 40.

The material that can be used for the reflective layer 52 may comprise, for example, Au, Ag, Al, Ti, Pb, Cr, Mo, W, Ta, or an alloy thereof. Ag is not suitable when the protective layers contain sulfur, in order to avoid defects of the optical disc caused by the production of silver sulfide (Ag₂S) after a long period of time of storage.

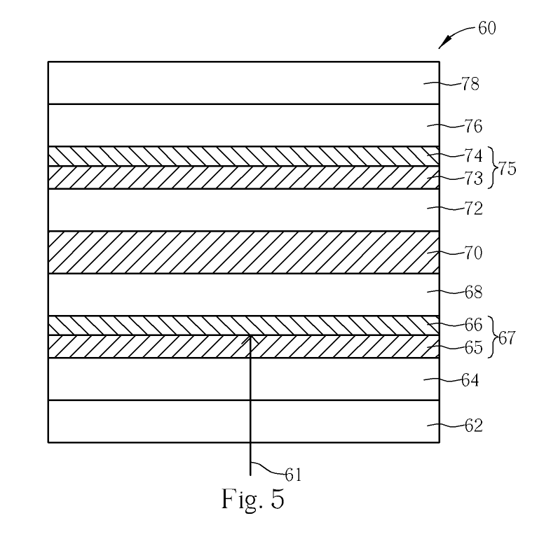

Please refer to FIG. 5. FIG. 5 shows further another embodiment of the optical storage medium 60 according to the present invention. The optical storage medium 60 is an optical disc with dual recording layers comprising a substrate 62, a first protective layer 64, a recording layer 67 comprising a metal layer 65 and a metal layer 66, a second protective layer 68, an interval layer 70, a protective layer 72, a recording layer 75 comprising a metal layer 73 and a metal layer 74, a third protective layer 76, and a covering layer 78.

The optical storage medium 60 comprises two recording layers 67 and 75. The recording layer 67 comprises a multiple metal layer, for example, a metal layer 65 and a metal layer 66, and the recording layer 75 also comprises a multiple metal layer, for example, a metal layer 73 and a metal layer 74. Materials of the metal layers are, for example, the indium layer and the tin layer mentioned above. The protective layers are positioned on a top surface and a bottom surface of the entire multiple metal layers for protection, and an interval layer 70 is positioned between the two recording layers. Material of the interval layer may comprise, for example, UV resins. Thus, a storage medium with a single-sided dual layer structure is formed, and the laser beam 61 is utilized to form a recorded mark.

In addition, a reflective layer can be positioned between the covering layer 78 and the third protective layer 76 of the optical storage medium 60.

The recording layers in the optical storage medium according to the present invention are not limited to two layers, and may be more. Each recording layer is a multiple metal layer, and protective layers are positioned on a top surface and a bottom surface of each recording layer for protection. Thus, stacks of layers are formed individually, and an interval layer is positioned between the stacks of layers.

Furthermore, two substrates 42 each with the first protective layer 44, the recording layer 46, the second protective layer 48, and the reflective layer 52 positioned thereon can be bonded together by an adhesive to form a storage medium with a double-sided single layer structure. According to this method, a storage medium with a double-sided multiple recording layers also can be formed.

### EMBODIMENTS

### Embodiment 1

At first, a PC substrate with a diameter of 120 mm, a thickness of 0.6 mm, and a track pitch of 0.74 um was provided. Argon (Ar) with a flow rate of 20 sccm was input in a vacuum chamber of 1×10⁻⁶ torr to form a vacuum of 5 mtorr, and a ZnS-SiO₂ layer (comprising 20 mole percent of SiO₂) with a thickness of 50 nm was formed on the PC substrate as a protective layer by sputtering. Secondly, an indium layer was formed on the protective layer with a thickness of 5 nm by a sputtering process using an indium target, and then a tin layer was formed on the indium layer with a thickness of 5 nm by a sputtering process using a tin target. Thirdly, a ZnS-SiO₂ layer (comprising 20 mole percent of SiO₂) with a thickness of 15 nm was formed using a sputtering process on the tin layer as a protective layer. Finally, PC was used to form a covering layer with a thickness of 0.6 mm to manufacture an optical storage medium according to the present invention.

### Embodiment 2

At first, a PC substrate with a diameter of 120 mm, a thickness of 0.6 mm, and a track pitch of 0.74 micrometers was provided. Argon (Ar) with a flow rate of 20 sccm was input in a vacuum chamber of 1×10⁻⁶ torr to form a vacuum of 5 mtorr, and a ZnS-SiO₂ layer (comprising 20 mole percent of SiO₂) with a thickness of 50 nm was formed on the PC substrate as a protective layer. Secondly, an indium layer was formed on the protective layer with a thickness of 5 nm by a sputtering process using an indium target, and then a tin layer was formed on the indium layer with a thickness of 5 nm by a sputtering process using a tin target. Thirdly, a ZnS-SiO₂ layer (comprising 20 mole percent of SiO₂) with a thickness of 15 nm was formed on the tin layer as a protective layer, and then an Al layer with a thickness of 100 nm was formed as a reflective layer by a sputtering process. Finally, PC was used to form a covering layer with a thickness of 0.6 mm to manufacture an optical storage medium according to the present invention.

### Testing Embodiments: Writing Test

A laser beam with a wavelength of 650 nm was used to test the optical storage medium of the embodiment 1 under three conditions as follows, respectively:

1. The writing power was 40 mW at 8 times speed, and carrier to noise ratio (CNR) of the 3T mark signal was 40 dB.

2. The writing power was 50 mW at 8 times speed, and CNR of the 3T mark signal was 45 dB.

3. The writing power was 55 mW at 8 times speed, and CNR of the 3T mark signal was 46 dB.

A laser beam with a wavelength of 650 nm to was used to test the optical storage medium of the embodiment 2 under three conditions as follows, respectively:

1. The writing power was 40 mW at 8 times speed, and carrier to noise ratio (CNR) of the 3T mark signal was 42 dB.

2. The writing power was 50 mW at 8 times speed, and CNR of the 3T mark signal was 46 dB.

3. The writing power was 55 mW at 8 times speed, and CNR of the 3T mark signal was 46 dB.

In general, when CNR is more than 45 dB, it means the optical storage medium possesses commercial value. Accordingly, the optical storage medium of the present invention absolutely can be applied in the industry.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical storage medium, comprising:
a substrate;
a first protective layer, positioned on the substrate;
a first multiple metal recording layer, positioned on the first protective layer;
a second protective layer, positioned on the first multiple metal recording layer; and
a covering layer, positioned on the second protective layer;
wherein a recorded mark is produced at an interface between two adjacent metal layers of the first multiple metal recording layer by irradiation of a laser beam on the interface and has a different reflectivity from those of the two adjacent metal layers.

2. The optical storage medium of claim 1, wherein the first multiple metal recording layer comprises an indium layer and a tin layer.

3. The optical storage medium of claim 2, wherein a thickness of the indium layer is in the range of from about 3 nm to 50 nm.

4. The optical storage medium of claim 2, wherein a thickness of the tin layer is in the range of from about 3 nm to 50 nm.

5. The optical storage medium of claim 2, wherein the tin layer is positioned on the first protective layer, and the indium layer is positioned on the tin layer.

6. The optical storage medium of claim 2, wherein the indium layer is positioned on the first protective layer, and the tin layer is positioned on the indium layer.

7. The optical storage medium of claim 1, wherein the first protective layer and the second protective layer each comprise a dielectric layer or a composite dielectric layer.

8. The optical storage medium of claim 1, further comprising a reflective layer, positioned between the second protective layer and the covering layer.

9. The optical storage medium of claim 1, further comprising a stack layer or a plurality of stack layers between the second protective layer and the covering layer, and an interval layer is positioned between the stack layers, the stack layers comprising:
a second multiple metal recording layer; and
a third protective layer and a fourth protective layer, positioned on a top surface and a bottom surface of the second multiple metal recording layer, respectively.

10. The optical storage medium of claim 9, further comprising a reflective layer, positioned between the covering layer and the stack layer.

11. A method of manufacturing a recording layer of an optical storage medium, comprising:
providing a substrate, and a protective layer is positioned on the substrate; and
forming a multiple metal layer on the protective layer in sequence to form a recording layer of an optical storage medium.

12. The method of claim 11, wherein steps of forming the multiple metal layer on the protective layer in sequence are depositing an indium layer on the protective layer, and depositing a tin layer on the indium layer.

13. The method of claim 11, wherein steps of forming the multiple metal layer on the protective layer in sequence are depositing a tin layer on the protective layer, and depositing an indium layer on the tin layer.

14. The method of claim 11, wherein a physical vapor deposition process is utilized to form the multiple metal layer on the protective layer in sequence.

15. The method of claim 14, wherein a sputtering process is utilized to form the multiple metal layer on the protective layer in sequence.

16. The method of claim 15, wherein sputtering a tin layer on the protective layer first, and then sputtering an indium layer on the tin layer.

17. The method of claim 15, wherein sputtering an indium layer on the protective layer first, and then sputtering a tin layer on the indium layer.

18. A recording method for an optical storage medium comprising a multiple metal layer as a recording layer, comprising:
irradiating a laser beam on an interface between two adjacent metal layers of a multiple metal layer to change an irradiated part of the interface such that the irradiated part has a reflectivity different from those of the two adjacent metal layers to form a recorded mark.

19. The recording method of claim 18, wherein the multiple metal layer comprises two metal layers.

20. The recording method of claim 19, wherein the two metal layers are an indium layer and a tin layer, respectively.

21. The recording method of claim 18, wherein the laser beam is a blue ray laser.
